(19) United States
(12) Patent Application Publication
(10) Pub. No.: US 2008/0142285 A1
(43) Pub. Date: Jun. 19, 2008

(54) Airflow redirector

(75) Inventors: Sean P. McCurdy, Aurora, IL (US); Dale Robert Shatters, Plano, IL (US); Scott A. Pozzie, Aurora, IL (US); Peitong Jin, Dunlap, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/640,399

(22) Filed: Dec. 18, 2006

(51) Int. Cl. B60K 11/06; F01P 11/00; F01P 11/10; F01P 5/02; F01P 5/08; F01P 9/04; F01P 1/00

(52) U.S. Cl. 180/68.1; 123/41.49; 454/251

(57) ABSTRACT

A system for providing an airflow to an enclosure associated with a power source may include a power source enclosure configured to substantially enclose a power source and a cooling package located external to the power source enclosure, including an airflow provider configured to produce an airflow through the cooling package. The system may further include an airflow redirector, configured to receive a portion of the airflow produced by the airflow provider, wherein the airflow redirector is also configured to redirect the portion of the airflow such that the portion of the airflow is provided to the power source enclosure.

### TECHNICAL FIELD

The present disclosure relates generally to cooling systems and, more particularly, to enhancing cooling airflow within an enclosed power source compartment.

### BACKGROUND

Machines, including vocational vehicles, off-highway haul trucks, motor graders, wheel loaders, and other types of large machines associated with, for example, the construction and mining industries, are typically powered by internal combustion engines. Internal combustion engines are generally housed within a semi- or fully-enclosed engine compartment for the primary purpose of protecting the engine and associated components from the elements and the typically harsh elements in which the machines are operated. In certain operations, the housing is also important to keep debris away from the engine.

In operation, internal combustion engines and other power sources produce large amounts of heat which may lead to accumulation of heat within the enclosed power source compartment and a corresponding rise in temperature. This accumulated heat, while detrimental to the power source itself, may also cause other problems, particularly where the power source is operated in dusty or debris-heavy environments (e.g., a landfill). For example, power source compartment fires may be a problem where debris is ingested and allowed to accumulate within the power source compartment.

Therefore, it is of particular importance that waste heat from the power source and surrounding air be removed expeditiously and the accumulation of debris within the power source compartment minimized. To that end, power sources have been provided with one or more closed system fluid cooling packages as well as with varying forms of airflow for the power source. Such airflow can be provided to a power source in numerous ways, for example, a “push” system where cooling air is blown over and around the power source followed by circulation through a heat exchanger (e.g., a radiator) by a fan, a “pull” system where the fan creates a low pressure gradient within the power source compartment thereby pulling air through available vents (e.g., designed openings, assembly seams, and other vents) into the power source compartment, and/or a venturi system where hot exhaust gases escaping through a stack cause a low pressure gradient to be created within the stack, thereby drawing out air within the power source compartment through available vents. However, each of these systems may lead to additional debris and dust being introduced into the power source compartment as a result of the airflow of one or more of the systems.

One system for ventilating an enclosed engine compartment is described in U.S. Pat. No. 4,059,080 to Rudert (“the '080 patent”). The '080 patent discloses an air impeller arranged within a finned annular housing with an air guiding housing configured to direct flow from the air impeller into the engine compartment. The device allows the compressed flow from the air impeller to be throttled over an oil cooler and an optional fuel cooler before entering the low pressure area of the engine compartment.

While the system of the '080 patent may provide ventilation to an engine compartment, the device presents several problems. First, the arrangement requires multiple airflow components, including at least one centrifugal impeller for ventilating the engine compartment as well as separate airflow components for cooling a fluid associated with a cooling system of the engine. Further, because the system of the '080 patent utilizes a centrifugal fan, the pressures associated with the exit air may be high, but the volume low. This may lead to an insufficient airflow to replace power source compartment air quickly enough to avoid heat accumulation and potential debris ingestion, particularly when used in tandem with a venturi type cooling system. Such operation may result in dangerous conditions inside the engine compartment leading to damage and/or compartment fires, among other things.

The present disclosure is directed at overcoming one or more of the problems or disadvantages in the prior art control systems.

### SUMMARY OF THE DISCLOSURE

In one embodiment, the present disclosure is directed to a system for providing an airflow to an enclosure associated with a power source. The system may include a power source enclosure configured to substantially enclose a power source and a cooling package located external to the power source enclosure, including an airflow provider configured to produce an airflow through the cooling package. The system may further include an airflow redirector, configured to receive a portion of the airflow produced by the airflow provider, wherein the airflow redirector is also configured to redirect the portion of the airflow such that the portion of the airflow is provided to the power source enclosure.

In another embodiment, the present disclosure may be directed to a method for providing an airflow to an enclosure associated with a power source. The method may include inducing an airflow in a direction away from the enclosure associated with the power source, receiving, by an airflow redirector, at least a portion of the airflow, and redirecting the portion of the airflow such that the portion of the airflow is provided to the enclosure associated with the power source.

In yet another embodiment, the present disclosure may be directed to a machine with enhanced cooling airflow capabilities. The machine may include a frame, a power source, one or more traction devices operatively connected to the power source and the frame, and a power source enclosure configured to substantially enclose the power source. The machine may further include a cooling package located external to the power source enclosure, including an airflow provider configured to produce an airflow through the cooling package, and an airflow redirector configured to receive at least a portion of the airflow produced by the airflow provider, wherein the airflow redirector is also configured to redirect the portion of the airflow such that the portion of the airflow is provided to the power source enclosure.

### BRIEF DESCRIPTION OF THE DRAWINGS

FIG. 1A provides a diagrammatic perspective view of a machine according to an exemplary disclosed embodiment;

FIG. 1B provides a diagrammatic perspective view of a machine with an alternatively oriented cooling system according to an exemplary disclosed embodiment;

FIG. 2 is an exemplary embodiment of an airflow redirector consistent with one embodiment of the present disclosure;

FIG. 3 is an exemplary flowchart illustrating one method for utilizing the system of the present disclosure.

### DETAILED DESCRIPTION

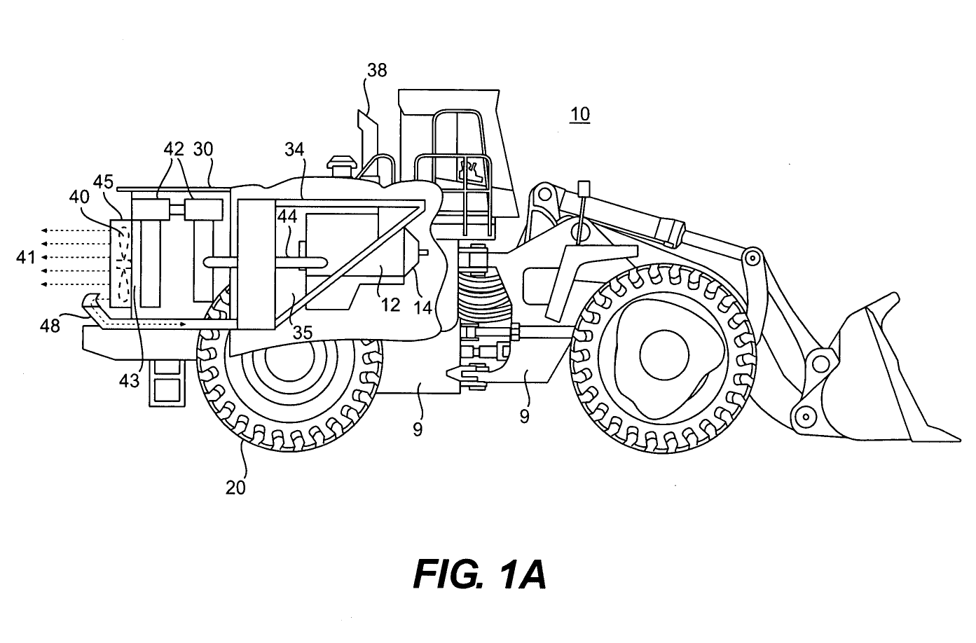

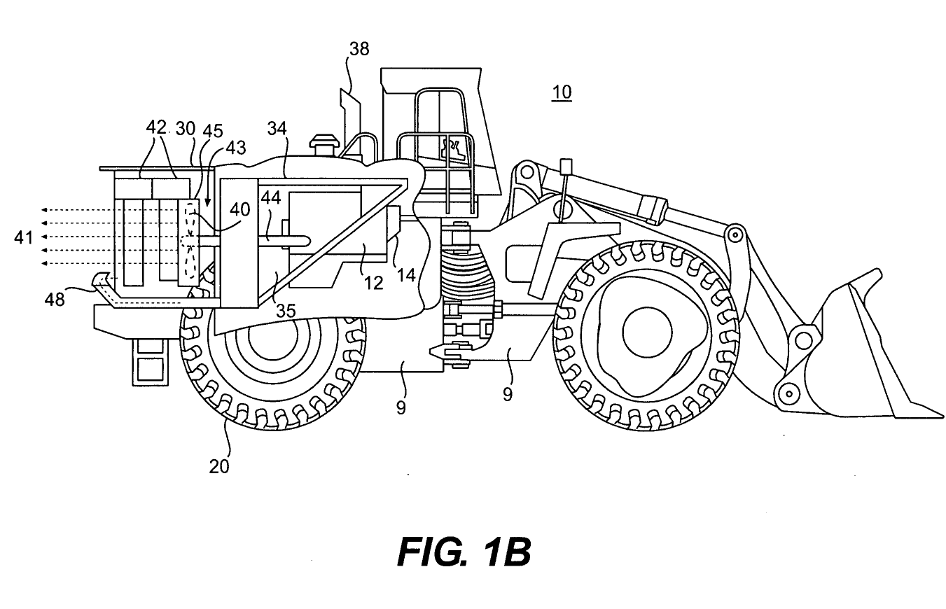

FIG. 1A provides a diagrammatic perspective view of a machine 10 according to an exemplary disclosed embodiment. Machine, as the term is used herein, refers to any machine that performs some type of operation associated with a particular industry, such as mining, construction, farming, etc. and operates between or within work environments (e.g., construction site, landfill, mine site, power plants, etc.). Non-limiting examples of machines include commercial machines, such as trucks, cranes, earth moving vehicles, mining vehicles, backhoes, material handling equipment, farming equipment, marine vessels, aircraft, and any type of machine that operates in a work environment.

A machine 10 may include a frame 9, a power source 12, a power-conversion unit 14, traction devices 20, cooling package 30, power source enclosure 34 forming a power source compartment 35, and venturi ventilation assembly 38. While machine 10 is illustrated as a wheel loader, machine 10 may be any type of machine that includes a power source 12.

Power source 12 may be any type of machine component configured to provide power to machine 10. Power source 12 may include machine components such as a diesel engine, a gasoline engine, a natural gas engine, a turbine engine, or a fuel cell operable to generate a power output. Alternatively, power source 12 may include a power-pick-up system configured to receive electrical energy from an off-board electrical transmission system, such as a trolley system.

Power source 12 may be enclosed within power source enclosure 34 such that power source 12 exists substantially within enclosed power source compartment 35. Power source enclosure 34 may include any material suitable for forming an enclosure of a desired contour and may further include various materials configured to minimize sound and/or air transmission between an outside area of power source enclosure 34 and power source compartment 35. For example, power source enclosure 34 may include a steel material formed such that power source 12 is substantially enclosed with minimal assembly seams around power source 12, thereby minimizing airflow through such seams into power source compartment 35. Further additional materials such as rubber, plastics, and/or other suitable materials may be utilized in tandem with power source enclosure 34 to limit air/sound transfer between power source compartment 35 and the exterior thereof. For example, rubber seals may be formed along the edges and seams of power source enclosure 34 and configured to substantially seal against frame 9. Additionally, various access doors or other devices allowing entry to engine compartment 35 may be provided on power source enclosure 34.

Power source enclosure 34 may further include a venturi ventilation assembly 38 in fluid communication with power source compartment 35 and the atmosphere. Venturi ventilation assembly 38 may further be in fluid communication with an exhaust system (not shown) associated with power source 12 and configured to provide a stream of exhaust gas to venturi ventilation assembly 38. Venturi ventilation assembly 38 may include appropriately shaped tubing or piping (e.g., a pipe with a tapering flow restriction) configured to generate a venturi effect when exposed to certain gas flows. Therefore, venturi ventilation assembly 38 may be configured to receive a flow of exhaust gas from an exhaust system (not shown), the exhaust gas may be caused to accelerate through a tapering restriction within venturi ventilation assembly 38, reducing the exhaust gas pressure (but accelerating the flow), thereby producing a partial vacuum within venturi ventilation assembly 38. This vacuum or “venturi effect” may be configured to cause a flow of air at a higher pressure to be drawn from power source compartment 35 through venturi ventilation assembly 38 and exhausted, with the flow of exhaust gas, to the atmosphere. Power source enclosure 34 may include more or fewer assemblies as desired. For example, a stack may be provided external to power source enclosure 34 to supply charge air from the atmosphere directly to power source 12.

In one embodiment, power-conversion unit 14 may be operatively coupled to power source 12. Power-conversion unit 14 may be any type of device configured for converting at least a portion of the power output supplied by power source 12 into a form useable at traction devices 20. For instance, power-conversion unit 14 may be a mechanical transmission including planetary gears configured to modify gear ratios associated with power-conversion unit 14. In another embodiment, power-conversion unit 14 may include an electric generator that converts at least a portion of the power output of power source 12 into electrical energy. Power-conversion unit 14 may also be a hydraulic pump that converts at least a portion of the power output of power source 12 into a flow of pressurized fluid, or any other power conversion device.

Multiple traction devices 20 may be operatively coupled to power-conversion unit 14 and configured to propel machine 10. While traction devices 20 are illustrated as wheels, they may also be track units or any other device adapted to receive power from power-conversion unit 14.

Cooling package 30 may be located externally to power source enclosure 34 and may further be located anywhere on machine 10. For example, cooling package 30 may be located on a front, back, or side of machine 10. Cooling package 30 may include an airflow provider 40, one or more fluid cooling heat exchangers 42, one or more cooling lines 44, and an airflow redirector 48. Portions of cooling package 30 may be fluidly connected to a cooling system associated with power source 12 and configured to cool a cooling fluid associated with power source 12. Fluid cooling heat exchanger 42 may include shell and tube heat exchangers, plate heat exchangers, coil heat exchangers, regenerative heat exchangers, and/or any other suitable heat exchanger. Further, one or more fluid cooling heat exchangers 42 may be used, for example, a charge-air cooler, an oil cooler, and a radiator, among others, may be provided within cooling package 30. For example, fluid cooling heat exchanger 42 may be fluidly connected to fluid jackets of power source 12 via cooling lines 44, such that a cooling fluid may be caused to circulate between power source 12 and fluid cooling heat exchanger 42. Fluid cooling heat exchanger 42 may further include passages configured to allow a flow of air to pass through such passages while contacting other passages associated with the cooling fluid. As the flow of air contacts various surfaces of fluid cooling heat exchanger 42, the airflow may absorb heat from the cooling fluid.

Airflow provider 40 may include one or more fans, such as an axial fan, and/or any other device configured to impart a velocity to surrounding air. Airflow provider 40 may have a high pressure section 41 (e.g., exhaust side of a fan) and a low pressure section 43 (e.g., suction side of fan) thereby allowing airflow provider 40 to accomplish either a push or a pull type airflow. FIG. 1A illustrates a pull type configuration of airflow provider 40, while FIG. 1B illustrates a push type configuration of airflow provider 40. Airflow provider 40 may be located external to power source enclosure 34 and configured to produce an airflow, the airflow being directed through cooling package 30 and caused to contact one or more fluid cooling heat exchangers 42. In other words, low pressure section 43 of airflow provider 40 may be adjacent to power source enclosure 34 with high pressure section 41 of airflow provider 40 facing away from power source enclosure 34. The flow rate of air produced by airflow provider 40 may be significantly higher than (e.g., approximately 50 times) the flow rate of air from power source compartment 35 induced by venturi ventilation assembly 38. Further, the airflow produced by airflow provider 40 may be caused to contact fluid cooling heat exchanger 42 via push or pull type arrangement. For example, fluid cooling heat exchanger 42 may be mounted on low pressure section 43 of airflow provider 40 and fluidly connected via a shaped shroud 45, such that an airflow generated by airflow provider 40 is first pulled through fluid cooling heat exchanger 42 and then into low pressure section 43 of airflow provider 40. Alternatively, fluid cooling heat exchanger 42 may be mounted on high pressure section 41 of the airflow provider 40 such that the airflow may enter low pressure section 43 of airflow provider 40 and then exit high pressure section 41 of airflow provider 40 to be pushed through fluid cooling heat exchanger 42. Utilizing airflow in either manner may cause fluid cooling heat exchanger 42 to effect a filtering of the air passed through cooling package 30.

One or more cooling lines 44 may be in fluid connection with power source 12 and fluid cooling heat exchanger 42, and configured to carry a cooling fluid associated with power source 12. Cooling lines may include rubber hoses, metal tubing, and any other suitable material configured to carry a fluid. For example, a mixture of water and antifreeze may be circulated between a water jacket associated with power source 12 and fluid cooling heat exchanger 42 via one or more cooling lines 44 composed of steel tubing. Various fittings and/or clamping mechanisms may be utilized to ensure such circulation remains substantially uninterrupted during operation of power source 12. One of skill in the art will recognize that numerous materials may be used for constructing cooling lines 44 without departing from the scope of the present disclosure.

Airflow redirector 48 may be located near high pressure section 41 of airflow provider 40, and may be pre- or post-fluid cooling heat exchanger 42. Airflow redirector 48 may be configured to receive at least a portion of the airflow generated by airflow provider 40 and redirect that portion of the airflow such that the airflow is provided to the power source compartment 35 formed by power source enclosure 34.

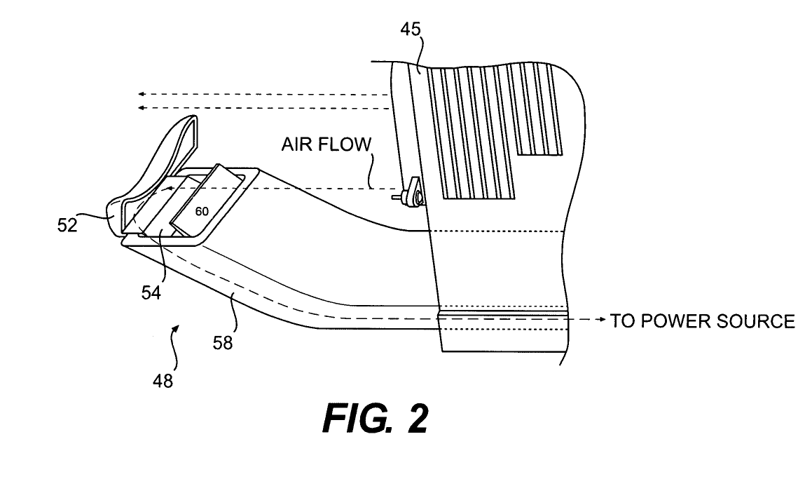

FIG. 2 is an exemplary embodiment of an airflow redirector 48 consistent with one embodiment of the present disclosure. Airflow redirector 48 may include a diverter device 52, a screen section 54, airflow control section 60, and a duct section 58. Duct section 58 may include an internal passage and may span the length from a location near high pressure section 41 of airflow provider 40 to power source compartment 35. The internal passage of duct section 58 may, therefore, be configured to carry air from outside high pressure section 41 of airflow provider 40 to a location inside power source compartment 35. Further, duct section 58 may be designed to provide for minimal boundary layer resistance in a flow of air such that flow may be maximized through duct section 58. Therefore, duct section 58 may include sheet metal or other material, which may be shaped according to a design to maximize flow while successfully navigating around obstacles between power source compartment 35 and high pressure section 41 of airflow provider 40.

Diverter device 52 may be configured to receive or capture at least a portion of the cooling airflow generated by airflow provider 40 subsequent to such airflow having contacted fluid cooling heat exchanger 42. Diverter device 52 may be configured to capture the portion of the airflow provided by airflow provider 40 while exerting minimal backpressure on airflow provider 40. Therefore, diverter device 52 may include fiberglass and/or metal materials and the geometry associated with diverter device 52 may vary based on the type and flow patterns of airflow provider 40. Flow analysis may be undertaken for any desired airflow provider 40 such that a design for diverter device 52 may be determined. Alternatively, a standard diverter design similar to that shown may be utilized where desired. One of skill in the art will recognize that any number of designs may be utilized for capturing a portion of the airflow while minimizing back pressure associated with airflow provider 40 without departing from the scope of the present disclosure.

Diverter device 52 may be in contact with and/or affixed to duct section 58. In one embodiment, diverter device 52 may be configured to pivot and/or “swing away” from duct section 58. For example, diverter device may be operatively connected to duct section 58 by a pin or swivel (not shown) and a locking device (not shown). Upon unlocking of the locking device, diverter device may be enabled to pivot away and/or be removed from duct section 58. Such a configuration may allow for access during cleaning and other tasks associated with components of airflow redirector 48.

Diverter device 52 may further be configured to direct the portion of air received from airflow device 40 into duct section 58. This may thereby effect a “redirection” of the airflow from airflow provider 40. In one embodiment, this redirection may result in the airflow being redirected approximately 180 degrees including redirection achieved within duct section 58. Such redirection may result in the portion of the airflow being provided to the inside of power source compartment 35. One of skill in the art will recognize that other factors may be utilized when designing various components of airflow redirector 48. For example, diverter device 52 may further be designed such that redirection occurs with a particular efficiency, thereby resulting in a desired portion of air being redirected into duct section 58.

Airflow control section 60 may be configured to provide volume and/or other airflow control associated with airflow redirector 48. Airflow control section 60 may include rubber, metal, and/or other suitable materials designed to provide control of airflow redirected by diverter device 52. Airflow control 60 may be configured to pivot and/or otherwise move in response to signals from a controller (not shown). For example, airflow control section 60 may be communicatively connected to a controller (not shown) configured to determine an airflow volume flowing to engine compartment 35 via duct section 58. The controller (not shown) may further determine a desired airflow to engine compartment 35 based on algorithms, flow through venturi ventilation device 38, and/or other consideration. Airflow control section 60 may, therefore, receive signals from the controller (not shown) and react by pivoting or otherwise responding to control airflow into duct section 58. One of skill in the art will recognize that numerous other methods for controlling airflow to engine compartment 35 may be utilized without departing from the scope of the present disclosure.

Additionally, screen section 54 may be present at the boundary between diverter device 52 and duct section 58 to effect a filtering of smaller particles remaining in the airflow post fluid cooling heat exchanger 42. Screen section 54 may include a rigid or flexible screen-like material (e.g., aluminum screen, fiberglass screen, etc.) to separate fine particles out of the airflow captured and redirected by diverter device 52. Further, screen section 54 may be located at any point within duct section 58 and may include any suitable screen or mesh material. Such material may have high flow characteristics so as to limit the flow reduction resulting from screen section 54, while maximizing filtration.

### INDUSTRIAL APPLICABILITY

The present disclosure may be applicable to any machine that includes a power source 12 resulting in heat generation. Systems and methods of the present disclosure may be particularly applicable where such a power source is enclosed by a power source enclosure for purposes of limiting noise or debris intrusion in and around power source 12 and a venturi ventilation system is provided for purposes of cooling power source compartment 35. For example, a machine configured as a landfill compactor may be particularly susceptible to debris breaching power source enclosure 34 due to vacuum conditions caused by an airflow out of power source compartment 35 through venturi ventilation assembly 38. Therefore, the machine may be subjected to a risk of fire in the power source compartment 35 based on the high temperatures and debris accumulation. By utilizing systems and methods of the present disclosure, this risk may be limited by providing a compensating airflow to power source compartment 35, wherein flow rate associated with airflow redirector 48 is approximately equal to or greater than the exiting flow rate associated with the air exiting power source compartment 35 via venturi ventilation assembly 38.

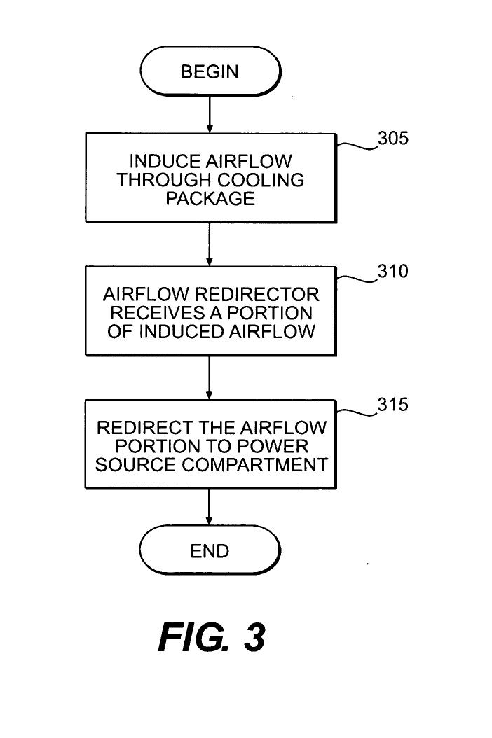

FIG. 3 is an exemplary flowchart 300 illustrating one method for utilizing the system of the present disclosure. Air may be induced to flow from a low pressure section 43 of airflow provider 40 to a high pressure section 41 of airflow provider 40. This airflow may be directed in a direction away from power source enclosure 34 associated with power source12 (step 305). Diverter device 52, being located near high pressure section 41 of airflow provider 40, may then receive at least a portion of the airflow induced by airflow provider 40. The airflow may be caused to contact fluid cooling heat exchanger 38 either via push or pull type circulation prior to being received by diverter device 52. For example, fluid cooling heat exchanger 42 may be mounted on low pressure section 43 of airflow provider 40 and connected via a shroud or other device such that air drawn into low pressure section 43 of airflow provider 40 is first pulled through fluid cooling heat exchanger 42. In this way, fluid cooling heat exchanger 42 may effect a filtering of the airflow (e.g., similar to a strainer or a screen). Following its reception by diverter device 52 and in combination with duct section 58, the portion of the airflow may then be redirected such that the received portion is provided to the inside of power source compartment 35 formed by power source enclosure 34.

The portion of air received by diverter device 52 and redirected through duct section 58 may be configured to be approximately equal to or greater than an airflow associated with venturi ventilation assembly 38. Further, it may be possible to adjust this flow by design and modification of diverter device 52, duct section 58, screen section 54, and other components of the disclosed system.

By utilizing systems and methods of the present disclosure, airflow may be redirected from a single airflow provider to a compartment associated with a power source. This may result in fewer cooling system components and, therefore, reduced costs and increased reliability. Further, because the systems and methods of the present disclosure may be designed to receive and redirect a portion of an airflow generated by an airflow provider, a volume of airflow may be utilized such that a power source compartment may remain under neutral pressure, positive pressure, or negative pressure depending on the desired configuration. By maintaining a neutral or positive pressure within a power source compartment, debris ingestion to a power source compartment may be substantially limited.

It will be apparent to those skilled in the art that various modifications and variations can be made in the disclosed systems and methods for providing enhanced airflow without departing from the scope of the disclosure. Additionally, other embodiments of the disclosed systems and methods for providing enhanced airflow will be apparent to those skilled in the art from consideration of the specification. It is intended that the specification and examples be considered as exemplary only, with a true scope of the disclosure being indicated by the following claims and their equivalents.

We claim:

1. A system for providing an airflow to an enclosure associated with a power source, the system comprising:
a power source enclosure configured to substantially enclose a power source;
a cooling package located external to the power source enclosure, including an airflow provider configured to produce an airflow through the cooling package; and
an airflow redirector, configured to receive a portion of the airflow produced by the airflow provider, wherein the airflow redirector is further configured to redirect the portion of the airflow such that the portion of the airflow is provided to the power source enclosure.

2. The system of claim 1, further comprising:
a venturi ventilation assembly in fluid communication with the power source enclosure; and
an exhaust assembly associated with the power source and configured to direct a flow of exhaust through the venturi ventilation assembly.

3. The system of claim 2, wherein the venturi ventilation assembly is configured to induce a second flow of air associated with the power source enclosure to flow out of the power source enclosure.

4. The system of claim 3, wherein a first flow rate associated with the at least a portion of the airflow is approximately equal to or greater than a second flow rate associated with the second flow of air.

5. The system of claim 1, wherein the airflow provider includes at least one of an axial-flow fan and a tangential-flow fan.

6. The system of claim 1, wherein the airflow is caused to contact a fluid cooling heat exchanger associated with the power source prior to being received by the airflow redirector.

7. The system of claim 6, wherein the fluid cooling heat exchanger is configured to effect a filtering of the airflow.

8. The system of claim 1, wherein the airflow redirector includes at least one filter configured to remove debris from the portion of the airflow.

9. The system of claim 1, wherein the airflow redirector includes:
a diverter device configured to receive the at least a portion of the airflow; and
a ducting device, fluidly connected to the diverter device and configured to direct the at least a portion of the airflow to the power source enclosure.

10. The system of claim 9 wherein the diverter device includes a fiberglass material.

11. The system of claim 1, further including:
an airflow control section configured to control a volume associated with the portion of the airflow;
a controller communicatively connected to the airflow control section.

12. A method for providing an airflow to an enclosure associated with a power source, the method comprising:
inducing an airflow in a direction away from the enclosure associated with the power source;
receiving, by an airflow redirector, at least a portion of the airflow; and
redirecting the at least a portion of the airflow such that the portion of the airflow is provided to the enclosure associated with the power source.

13. The method of claim 12, further including, inducing, via a venturi effect, a second flow of air to exit the enclosure associated with the power source.

14. The method of claim 13, wherein a flow rate associated with the at least a portion of the airflow is approximately equal to or greater than a flow rate associated with the second flow of air.

15. The method of claim 12, further including causing the airflow to contact a fluid cooling heat exchanger associated with the power source prior to being received by the airflow redirector.

16. The method of claim 15, wherein the fluid cooling heat exchanger is configured to effect a filtering of the airflow.

17. The method of claim 12, further including, filtering the at least a portion of the airflow following receipt by the airflow redirector.

18. The method of claim 12, wherein the inducing is performed by at least one of an axial-flow fan and a tangential-flow fan.

19. The method of claim 12, further including controlling a volume associated with the portion of the airflow.

20. A machine with enhanced cooling airflow capabilities, the machine comprising:
a frame;
a power source;
one or more traction devices operatively connected to the power source and the frame;
a power source enclosure configured to substantially enclose the power source;
a cooling package located external to the power source enclosure, including an airflow provider configured to produce an airflow through the cooling package; and
an airflow redirector, configured to receive at least a portion of the airflow produced by the airflow provider, wherein the airflow redirector is further configured to redirect the portion of the airflow such that the portion of the airflow is provided to the power source enclosure.

21. The machine of claim 19, wherein the airflow is caused to contact a fluid cooling heat exchanger associated with the power source prior to being received by the airflow redirector.

22. The machine of claim 19, wherein the airflow redirector includes:
a diverter device configured to receive the at least a portion of the airflow; and
a ducting device fluidly connected to the diverter device and configured to direct the at least a portion of the airflow to the power source enclosure.

23. The machine of claim 19, further including:
a venturi ventilation assembly in fluid communication with the power source enclosure; and
an exhaust assembly associated with the power source and configured to direct a flow of exhaust through the venturi ventilation assembly.
